(19) United States
(12) Patent Application Publication
(10) Pub. No.: US 2021/0260593 A1
(43) Pub. Date: Aug. 26, 2021

(54) HEATED HERBAL GRINDER AND METHOD THEREFOR

(71) Applicant: KIMS INDUSTRY, Daejeon (KR)

(72) Inventors: Seung Kuk AN, Daejeon (KR); Gun Ryung LEE, Daejeon (KR); Justin KRUIDENIER, Phoenix, AZ (US)

(21) Appl. No.: 17/158,884

(22) Filed: Jan. 26, 2021

Related U.S. Application Data
(60) Provisional application No. 62/980,843, filed on Feb. 24, 2020.

(51) Int. Cl. B02C 4/44; B02C 21/00; B02C 4/02; B02C 4/28

(52) U.S. Cl. CPC B02C 4/44; B02C 4/286; B02C 4/02; B02C 21/00

(57) ABSTRACT

An herbal grinding device has a housing. A chute is formed through the housing. A shredding mechanism is positioned within the chute. The shredding mechanism moves an herbal product through the chute while shredding the herbal product. The shredding mechanism is heated to prevent resin from the herbal product from sticking to the shredding mechanism.

### RELATED APPLICATIONS

This patent application is related to U.S. Provisional Application No. 62/980,843 filed Feb. 24, 2020, entitled “HEATED HERBAL GRINDER AND METHOD THEREFOR”, in the name of Gun Ryung Lee, and which is incorporated herein by reference in its entirety. The present patent application claims the benefit under 35 U.S.C § 119(e).

### TECHNICAL FIELD

The present application generally relates to an herbal grinder, and more specifically, to an electrical herbal grinder that uses a heating mechanism that prevents resin from building up and collecting on the shredding blades.

### BACKGROUND

The use of cannabis for treatment of select medical conditions has become more widely known. Many governmental agencies have legalized cannabis for medical and/or recreational purposes. However, use of cannabis generally requires the grinding or cutting of cannabis flowers.

Most individuals use a mechanical grinder to break up the cannabis into consumable particles/fragments. Most manual grinders have two pieces with cooperating cutting pegs that are aligned in such a way that when both pieces are rotated, the cutting pegs pulverize the cannabis.

While mechanical grinders do work, they may only grind a small amount at a time and are not suitable for larger commercial applications. Further, mechanical grinders apply an uneven amount of force on the ground material. This may cause the cannabis to be unevenly grounded. Other issues may also arise with the use of mechanical grinders. For example, due to the small nature of these devices, these devices may be easily dropped which can cause the mechanical grinder to break open and spill the contents. Also, most mechanical grinders require two hands to dispense, which is inconvenient for the user.

Electronic grinders have been made to grind cannabis in both large and small quantities. However, in most electric grinders, the grinding blades tend to clog up and need to be cleaned after every use. If the grinding blades are not cleaned, the grinding blades may from a residual build up on the surface of the grinding blades. This may cause the cannabis to be unevenly grinded. The residual build up further may cause the grinding blades to clog/jam which may damage the electronic grinder. Further, electronic grinders are difficult to take apart and clean.

Therefore, it would be desirable to provide a system and method that overcomes the above.

### SUMMARY

In accordance with one embodiment, an herbal grinding device is disclosed. The herbal grinding device has a housing. A chute is formed through the housing. A shredding mechanism is positioned within the chute. The shredding mechanism moves an herbal product through the chute while shredding the herbal product. The shredding mechanism is heated to prevent resin from the herbal product from sticking to the shredding mechanism.

In accordance with one embodiment, an herbal grinding device is disclosed. The herbal grinding device has a housing. A chute is formed through the housing. A shredding mechanism is positioned within the chute. The shredding mechanism moves an herbal product through the chute while shredding the herbal product. The shredding mechanism is heated to prevent resin from the herbal product from sticking to the shredding mechanism. The shredding mechanism has a pair of cutting devices horizontally aligned within the chute shredding the herbal product. Each of the pair of cutting devices has a hollow tube member and a plurality of cutting blades positioned on the hollow tube. A heating element is positioned within the hollow tube of each of the pair of cutting devices. A feeding mechanism is positioned above the pair of cutting devices moving the herbal product to the pair of cutting devices.

In accordance with one embodiment, an herbal grinding device is disclosed. The herbal grinding device has a housing. A chute is formed through the housing. A shredding mechanism is positioned within the chute. The shredding mechanism moves an herbal product through the chute while shredding the herbal product. The shredding mechanism is heated to prevent resin from the herbal product from sticking to the shredding mechanism. The shredding mechanism has a pair of cutting devices horizontally aligned within the chute shredding the herbal product. Each of the pair of cutting devices has a hollow tube member and a plurality of cutting blades positioned on the hollow tube. A feeding mechanism is positioned above the pair of cutting devices moving the herbal product to the pair of cutting devices. The feeding mechanism uses a pair of feeding members. Each feeding members has a carriage and a plurality of feeding blades positioned on the carriage. A heating element is positioned within the hollow tube of each of the pair of cutting devices. A temperature sensor is coupled to the heating element. A heating controller is coupled to the heating element.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1A is an elevated perspective view on an exemplary embodiment of an electronic grinder in accordance with an embodiment of the present invention;

FIG. 1B is a bottom perspective view on an exemplary embodiment of the electronic grinder in accordance with an embodiment of the present invention;

FIG. 2A is a front view on an exemplary embodiment of the electronic grinder in accordance with an embodiment of the present invention;

FIG. 2B is a rear view on an exemplary embodiment of the electronic grinder in accordance with an embodiment of the present invention;

FIG. 3A is a right-side view of an exemplary embodiment of the electronic grinder in accordance with an embodiment of the present invention;

FIG. 3B is a left side view of an exemplary embodiment of the electronic grinder in accordance with an embodiment of the present invention;

FIG. 4 is a top view on an exemplary embodiment of the electronic grinder in accordance with an embodiment of the present invention;

FIG. 5 is an elevated perspective view on an exemplary embodiment of a hopper module of the electronic grinder in accordance with an embodiment of the present invention;

FIG. 6 is a cross-sectional view on an exemplary embodiment of the hopper module of the electronic grinder in accordance with an embodiment of the present invention;

FIG. 7 is an elevated perspective view on an exemplary embodiment of the electronic grinder with a top cover removed in accordance with an embodiment of the present;

FIG. 8A is an elevated front perspective view on an exemplary embodiment of a cutting device used in the cutting mechanism in accordance with an embodiment of the present invention;

FIG. 8B is an elevated rear perspective view on an exemplary embodiment of the cutting device used in the cutting mechanism in accordance with an embodiment of the present invention;

FIG. 8C is a magnified side view on an exemplary embodiment of the cutting device used in the cutting mechanism in accordance with an embodiment of the present invention;

FIG. 9A is a perspective view on an exemplary embodiment of one member of the cutting device used in the cutting mechanism in accordance with an embodiment of the present invention;

FIG. 9B is a perspective view on an exemplary embodiment of a cutting blade of the member shown in FIG. 9A in accordance with an embodiment of the present invention;

FIG. 10A is a perspective view on an exemplary embodiment of one member of a feeding unit used in the cutting mechanism in accordance with an embodiment of the present invention;

FIG. 10B is a perspective view on an exemplary embodiment of a feeding blade of the member shown in FIG. 10A in accordance with an embodiment of the present invention;

FIG. 11 is a cross-sectional view on an exemplary embodiment of the member of the cutting device shown in FIG. 9A in accordance with an embodiment of the present invention; and

FIG. 12 is a cross-sectional view on the member of the cutting device shown in FIG. 9A in accordance with an embodiment of the present invention.

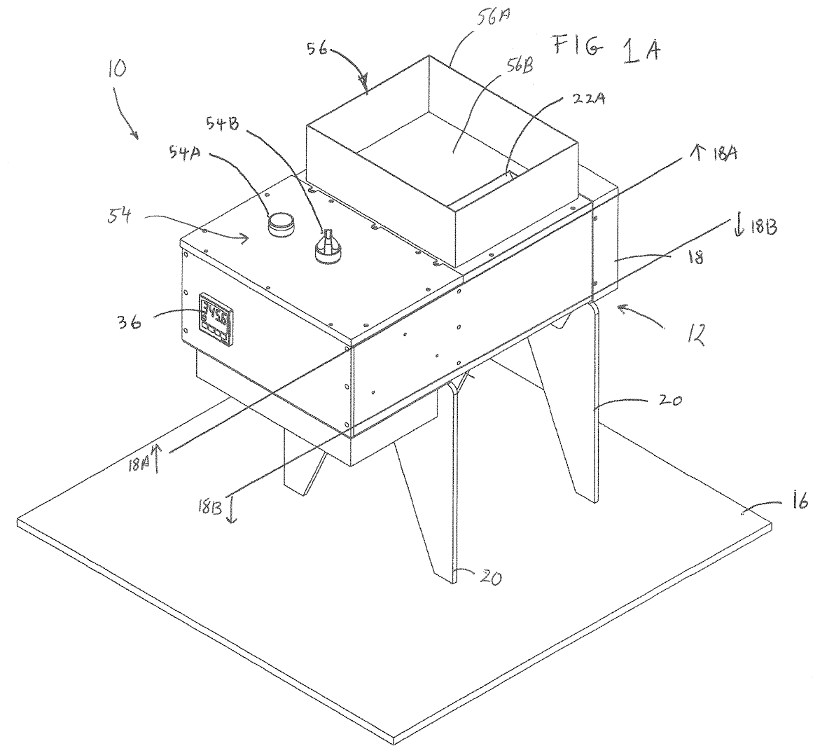

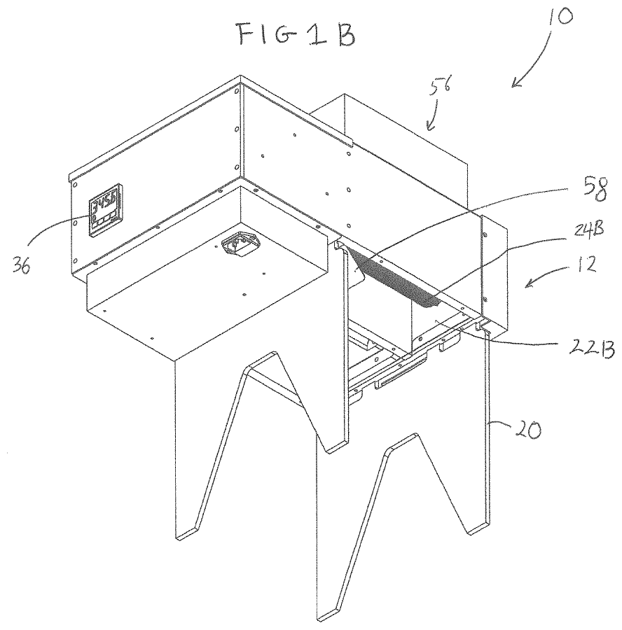

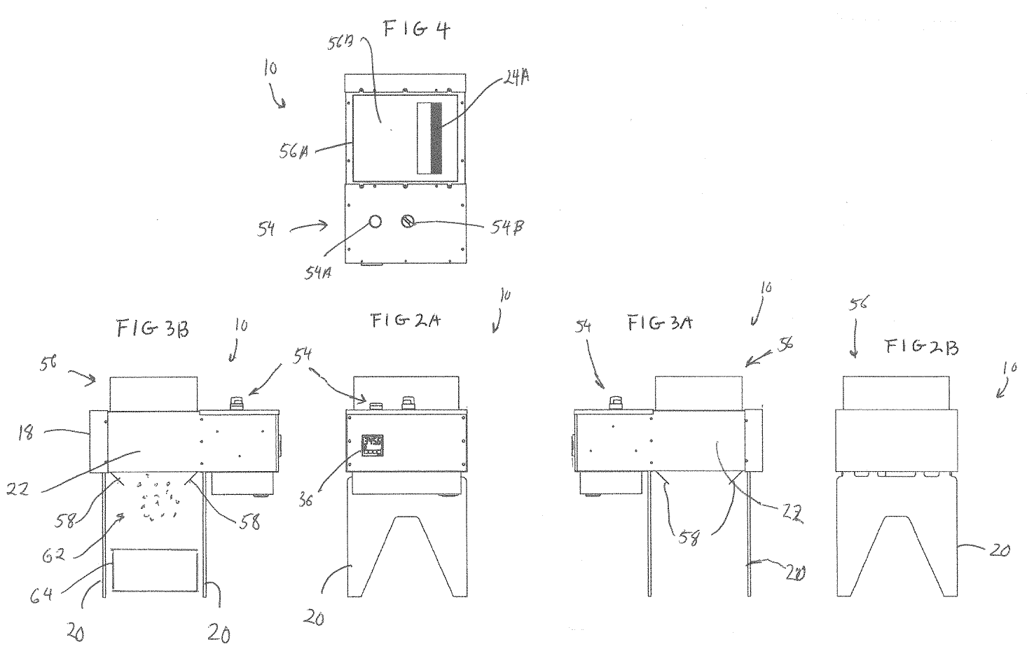

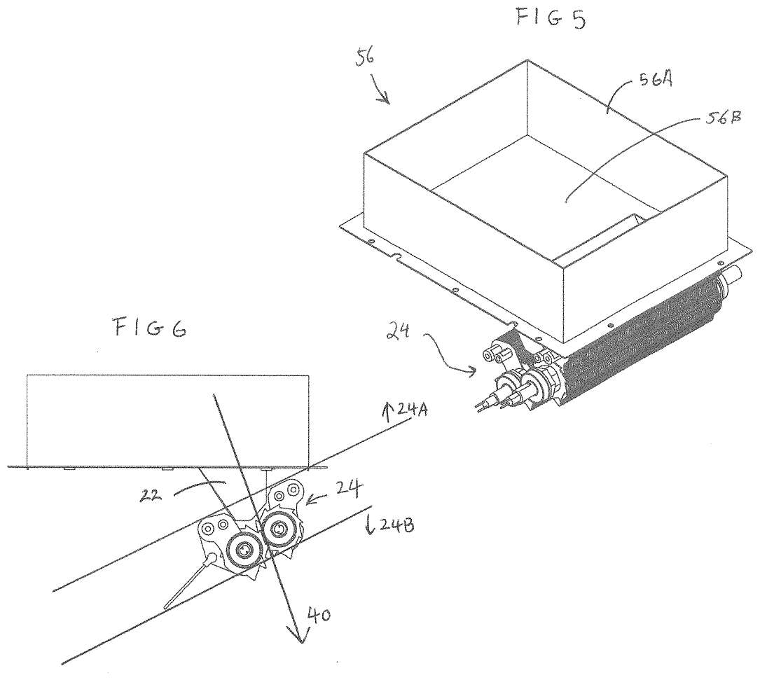

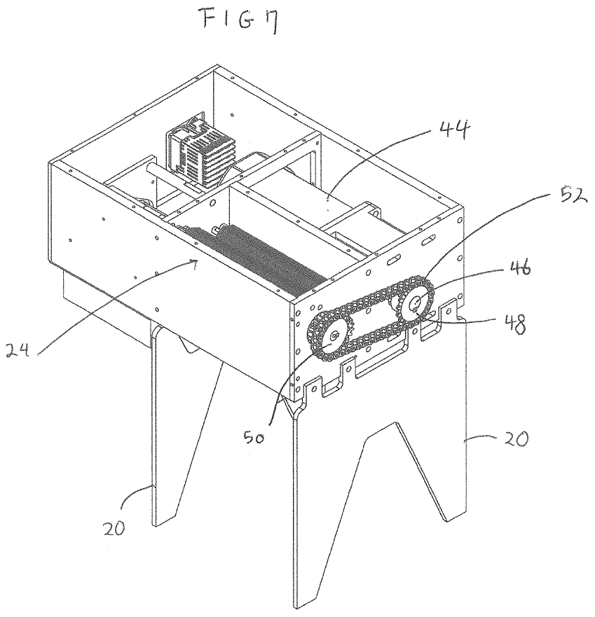

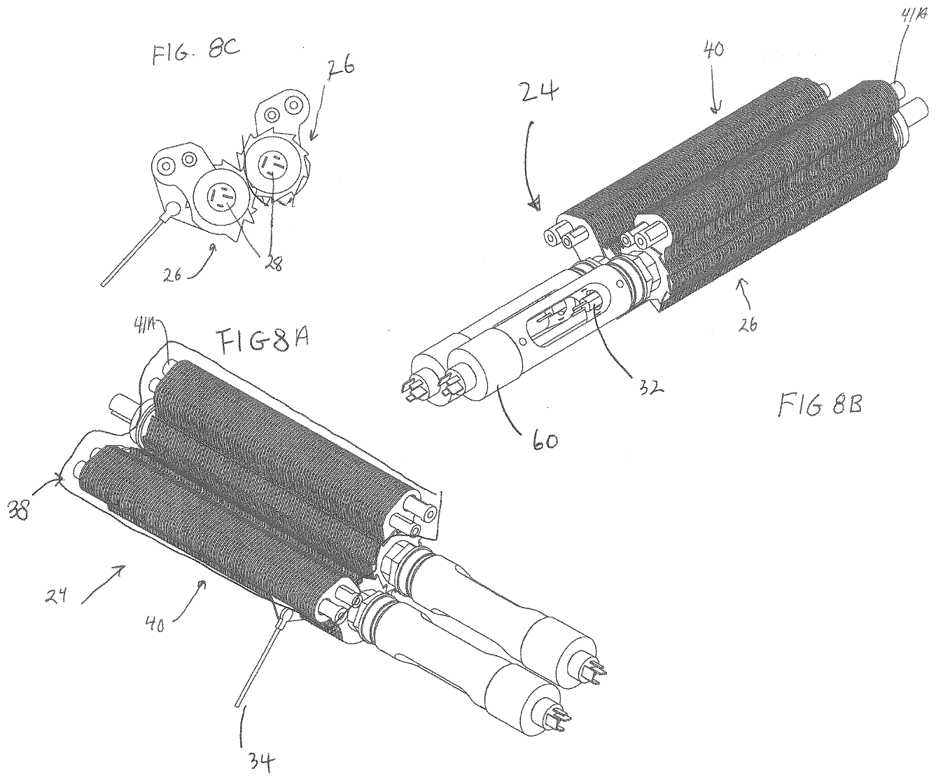

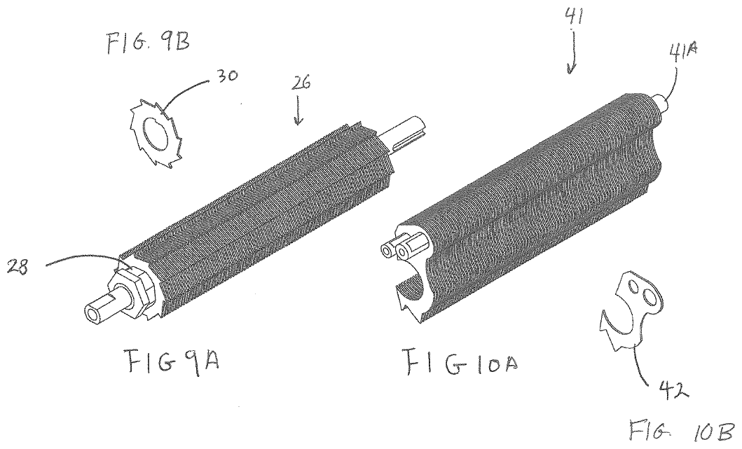

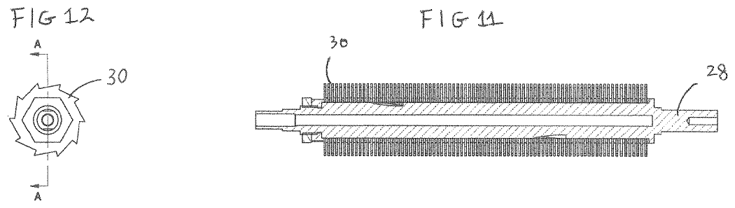

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose an electronic herb grinder. The electronic herb grinder has a heading unit which warms the grinding blades. The warming of the grinding blades prevents the build-up of resin from the cannabis from forming on the grinding blades. The heating unit may be programmed to run within a range of temperature where the cannabis is not burnt but warm enough to keep the resin from forming/sticking on the grinding blades. The electronic herb grinder is designed to allow the grinding blades to be easily inserted and removed for cleaning purposes.

Referring to the FIGs., an electrical grinding unit 10 (hereinafter grinding unit 10) may be seen. The grinding unit 10 may have a base 12. The base 12 may be used to house and hold the grinding unit 10. In accordance with one embodiment, the base 12 may be used to house and hold the grinding unit 10 above a floor 16. The base 12 may have a housing 18. The housing 18 may be used to hold and protect components of the grinding unit 10. The housing 18 may come in any geometric configuration. In the present embodiment, the housing 18 is rectangular in shape. However, this is shown as an example, and should not be seen in a limiting manner. A plurality of legs 20 may extend down from the housing 18. The legs 20 may be used to hold the grinding unit 10 at a predetermined height above the floor 16.

A chute 22 may be formed through the housing 18. The chute 22 may extend from a top surface 18A of the housing 18, through the housing 18 and out a rear surface 18B of the housing 18. The chute 22 may have an open top area 22A and an open bottom area 22B.

Located within the chute 22 may be a shredding unit 24. The shredding unit 24 may be used to shred the cannabis positioned within the open top area 22A of the chute 22. The shredding unit 24 may be positioned such that a portion of the shredding unit 24 may be enclosed within the housing 18. A top section 24A of the shredding unit 24 may be viewable through the open top area 22A of the chute 22. A bottom section 24B of the shredding unit 24 may be viewable through the open bottom area 22B of the chute 22.

In accordance with one embodiment, the shredding unit 24 may be formed of a pair of cutting devices 26. Each cutting device 26 may slide into a track 38. Each of the pair of cutting devices 26 may be positioned proximate one another and aligned horizontally parallel with each other within the chute 22. In operation, the cutting devices 26 may rotate thereby grinding the cannabis placed in the grinding unit 10.

In accordance with one embodiment, each cutting device 26 may be formed of a hollow tube member 28. A plurality of cutting blades 30 may be formed on the hollow tube member 28. In accordance with one embodiment, the cutting blades 30 may be approximately evenly spaced along a length of the tube member 28. The cutting devices 26 may be aligned such that cutting blades 30 on one hollow tube member 28 may be aligned and positioned between a pair of associated cutting blades 30 on the other hollow tube member 28. A gap may be formed between the cutting blades 30 on one hollow tube member 28 and the associated cutting blades 30 on the other hollow tube member 28 to prevent the cutting blades 30 from hitting one another when the pair of cutting devices 26 are rotated. Each hollow tube member 28 may slide into the track 38 to properly position and align the cutting devices 26. The alignment and spacing of the cutting devices 26 may allow for consistent even sized particles to be formed when the cannabis is run through the cutting blades 30. A rotary joint 60 may be positioned at an end of each cutting device 26. The rotary joint 60 may be used to prevent cables from twisting while the cables deliver power to the grinding unit 10. In accordance with one embodiment, the rotary joint 60 may be used to prevent cables from twisting while the cables deliver power to a heating element 32.

The heating element 32 may be positioned within each hollow tube member 28. The heating element 32 may warm up the hollow tube member 28. The heat may also transfer from the hollow tube member 28 to the cutting blades 30. The heat from the heating element 32 may warm the hollow tube member 28 and/or the cutting blades 30 to prevent any resin from building/stacking upon the hollow tube member 28 and/or the cutting blades 30 when the cutting devices 26 may be grinding the cannabis. Preventing the any resin from building/stacking upon the hollow tube member 28 and/or the cutting blades 30 may prevent the grinding unit 10 from jamming. Preventing the any resin from building/stacking upon the hollow tube member 28 and/or the cutting blades 30 may also reduce the number of times the shredding unit 24 may need to be broken down and cleaned.

Each heating element 32 may be coupled to a temperature sensor 34. The temperature sensor 34 may be used to monitor the temperature of the heating element 32 in order to control and keep the temperature of the respective heating element 32 at a desired temperature. The temperature sensor 34 may be coupled to a heater controller 36. The heater controller 36 may be used to set the heating element 32 at a desired temperature. In general, the temperature set is within a range of temperature where the cannabis is not being burnt but warm enough to prevent resin from building/stacking upon the hollow tube member 28 and/or the cutting blades 30. Once the temperature is set via the heater controller 36, the heater controller 36 may send a signal to heat the respective heating elements 32 to the desired temperature. The temperature sensor 34 may monitor the temperature of the heating element 32. Once the desired temperature has been reached, the temperature sensor 34 may signal the heater controller 36 that the hollow tube member 28 and/or the cutting blades 30 are at the desired temperature. During operation of the grinding unit 10, the temperature sensor 34 may continue to monitor the temperature of the respective heating elements 32 and signal the heater controller 36 to adjust the temperature when the current temperature of the respective heating elements 32 are above and/or below a desired temperature range. In accordance with one embodiment, the temperature sensor 34 may be positioned on one of the cutting blades 30.

A feeding mechanism 40 may be positioned above the pair of cutting devices 26. The feeding mechanism 40 may be used to move the cannabis towards the pair of cutting devices 26. In accordance with one embodiment, the feeding mechanism 40 may be formed of a pair of feeding members 41. Each feeding member 41 positioned above a corresponding cutting device 26. Each feeding member 41 may have a carriage 41A. A set of fixed blades 42 may be positioned on the carriage 41A. The carriage 41A may positioned each of the set of fixed blades 42 to be aligned horizontally parallel with each other within the chute 22 and above the pair of cutting devices 26. A gap may be formed between the fixed blades 42. Movement of the carriage 41A may allow the fixed blades 42 to move the cannabis towards the pair of cutting devices 26.

In order to rotate the pair of cutting devices 26, a motor 44 may be used. In accordance with one embodiment, the motor 44 may be an AC powered motor. The motor 44 may be coupled to an axle member 46. The axle member 46 may be coupled to a first sprocket member 48. A second sprocket member 50 may be coupled to the pair of cutting devices 26 and the carriage 41. A chain 52 may be used to connect the first sprocket member 48 to the second sprocket member 50. In operation, the motor 44 may rotate the axle member 46. Rotation of the axle member 46 causes the first sprocket member 48 to rotate. The chain 52 transfers the rotation of the first sprocket member 48 to the second sprocket member 50 causing the second sprocket member 50 to rotate. Rotation of the second sprocket member 50 may causes the carriage 41 to move thereby allowing the fixed blades 42 to move the cannabis towards the pair of cutting devices 26. Rotation of the second sprocket member 50 rotates the pair of cutting devices 26 thereby shredding the cannabis.

Control switches 54 may be coupled to the motor 44. The control switches 54 may be used to control the operation of the motor 44. The control switches 54 may be used to activate and deactivate the motor 44. The control switches 54 may consist of a power switch 54A and motor rotate direction switch 54B. The above is given as examples and should not be seen in a limiting manner. Other control switches 52 may be provided to control the operation of the grinding unit 10.

The grinding unit 10 may have a hopper 56. The hopper 56 may be formed on the top surface 18A of the housing 18. The hopper 56 may be used to direct the cannabis towards the chute 22. The hopper 56 may be formed of a container 56A having a sloped floor 56B. The sloped floor 58B may be slanted in the direction of the chute 22.

A pair of flaps 58 may be positioned on the rear surface 18B of the housing 18 at the bottom area of the chute 18. The flaps 58 may direct the cannabis 62 that has been grinded to a container 64 located at a bottom area of the chute 18.

The foregoing description is illustrative of particular embodiments of the application, but is not meant to be a limitation upon the practice thereof. The following claims, including all equivalents thereof, are intended to define the scope of the application.

What is claimed is:

1. An herbal grinding device comprising:
a housing;
a chute formed through the housing; and
a shredding mechanism positioned within the chute, wherein the shredding mechanism moves an herbal product through the chute while shredding the herbal product, the shredding mechanism being heated to prevent resin from the herbal product from sticking to the shredding mechanism.

2. The herbal grinding device of claim 1, wherein the shredding mechanism comprises:
a pair of cutting devices positioned within the chute shredding the herbal product;
a heating element positioned within each of the pair of cutting devices; and
a feeding mechanism positioned above the pair of cutting devices moving the herbal product to the pair of cutting devices.

3. The herbal grinding device of claim 2, comprising a temperature sensor coupled to the heating element.

4. The herbal grinding device of claim 2, comprising a heating controller coupled to the heating element.

5. The herbal grinding device of claim 2, wherein the pair of cutting devices are horizontally aligned within the chute.

6. The herbal grinding device of claim 2, wherein each of the pair of cutting devices comprises:
a hollow tube member; and
a plurality of cutting blades positioned on the hollow tube.

7. The herbal grinding device of claim 2, comprising a rotary joint coupled to one end of each of the pair of cutting devices.

8. The herbal grinding device of claim 2, wherein the feeding mechanism comprises:
a pair of feeding members, each feeding member comprising:
a carriage; and
a plurality of feeding blades positioned on the carriage.

9. The herbal grinding device of claim 1, comprising:
a motor coupled to the shredding mechanism;
a pair of sprocket members coupled to the motor and the shredding mechanism;
a chain coupled to the motor and the pair of sprocket members.

10. The herbal grinding device of claim 1, comprising a hopper attached to the body above the chute.

11. An herbal grinding device comprising:
a housing;
a chute formed through the housing; and
a shredding mechanism positioned within the chute, wherein the shredding mechanism moves an herbal product through the chute while shredding the herbal product, the shredding mechanism being heated to prevent resin from the herbal product from sticking to the shredding mechanism, wherein the shredding mechanism comprises:
a pair of cutting devices horizontally aligned within the chute shredding the herbal product, wherein each of the pair of cutting devices comprises:
a hollow tube member, and
a plurality of cutting blades positioned on the hollow tube;
a heating element positioned within the hollow tube of each of the pair of cutting devices; and
a feeding mechanism positioned above the pair of cutting devices moving the herbal product to the pair of cutting devices.

12. The herbal grinding device of claim 11, comprising a temperature sensor coupled to the heating element.

13. The herbal grinding device of claim 11, comprising a heating controller coupled to the heating element.

14. The herbal grinding device of claim 11, comprising a rotary joint coupled to one end of each of the pair of cutting devices.

15. The herbal grinding device of claim 11, wherein the feeding mechanism comprises:
a pair of feeding members, wherein each feeding member comprises:
a carriage; and
a plurality of feeding blades positioned on the carriage.

16. The herbal grinding device of claim 11, comprising:
a motor coupled to the shredding mechanism;
a pair of sprocket members coupled to the motor and the shredding mechanism;
a chain coupled to the motor and the pair of sprocket members.

17. The herbal grinding device of claim 11, comprising a hopper attached to the body above the chute.

18. An herbal grinding device comprising:
a housing;
a chute formed through the housing; and
a shredding mechanism positioned within the chute, wherein the shredding mechanism moves an herbal product through the chute while shredding the herbal product, the shredding mechanism being heated to prevent resin from the herbal product from sticking to the shredding mechanism, wherein the shredding mechanism comprises:
a pair of cutting devices horizontally aligned within the chute shredding the herbal product, wherein each of the pair of cutting devices comprises:
a hollow tube member; and
a plurality of cutting blades positioned on the hollow tube;
a feeding mechanism positioned above the pair of cutting devices moving the herbal product to the pair of cutting devices, wherein the feeding mechanism comprises a pair of feeding members, wherein each feeding member comprises:
a carriage; and
a plurality of feeding blades positioned on the carriage;
a heating element positioned within the hollow tube of each of the pair of cutting devices;
a temperature sensor coupled to the heating element; and
a heating controller coupled to the heating element.

19. The herbal grinding device of claim 18, comprising a rotary joint coupled to one end of each of the pair of cutting devices.

20. The herbal grinding device of claim 18, comprising a hopper attached to the body above the chute.
